(19) United States
(12) Patent Application Publication
(10) Pub. No.: US 2004/0000759 A1
(43) Pub. Date: Jan. 1, 2004

(54) Brush seal for a steam turbine and method of retrofitting

(75) Inventors: Norman Arnold Turnquist, Sloansville, NY (US); Thomas Martin Angeliu, Clifton Park, NY (US); Peter Louis Andresen, Schenectady, NY (US); Mark Edward Burnett, Buskirk, NY (US); Frederick George Baily, Ballston Spa, NY (US)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(73) Assignee: General Electric Company, Niskayuna, NY

(21) Appl. No.: 10/064,283

(22) Filed: Jun. 28, 2002

(51) Int. Cl. F16J 15/32

(52) U.S. Cl. 277/309

(57) ABSTRACT

A brush seal is provided wherein the brush seal is disposed in a section of a steam turbine for reducing leakage of a working fluid across a pressure drop. The brush seal comprises a bristle holder attachable to the steam turbine and a plurality of bristles comprising Ni, Cr, Mo, Fe, W, Mn, V, Si, and C.

### BACKGROUND OF INVENTION

The present invention relates generally to rotary machines, and more particularly to brush seals for rotary machines such as steam turbines.

Rotary machines include, without limitation, turbines for steam plants. A steam turbine has a steam path that typically includes, in serial-flow relationship, a steam inlet, a turbine, and a steam outlet. Steam leakage either out of steam path or into steam path from an area of higher pressure to an area of lower pressure is generally undesirable. For example, steam-path leakage in the turbine area of a steam turbine, between a rotor of the turbine and a circumferentially surrounding casing, will lower the efficiency of the steam turbine leading to increased fuel costs.

It is known in the art of steam turbines to position seals (e.g. brush seals or labyrinth-brush seals) with cobalt-based bristles in a circumferential array between the rotor of the turbine and the circumferentially surrounding casing to minimize steam-path leakage. Springs hold the seals radially inward against surfaces on the casing that establish radial clearance between the seal and a rotor but allow segments to move radially outward in the event of rotor contact. While the seals with cobalt-based bristles have proved to be quite reliable in steam turbines at temperatures between about 500° F. and about 1100° F. (also known as high temperatures) and pressures between about 140 psia and about 3500 psia (also known as high pressures), wear performance of such seals, in conjunction with a NiCrMoV or CrMoV rotor, degrade over time at temperatures between about 100° F. and about 500° F. (also known as low temperatures) and pressures up to 140 psia (also known as low pressures). In some cases, steam turbines used in nuclear plants comprise such seals with cobalt-based bristles that, at times, become radioactive if exposed to steam that has been exposed to neutron flux in the reactor. As a result, disposal of the seals as radioactive waste becomes problematic.

Accordingly, there is a need in the art for a brush seal having improved wear characteristics at low temperatures and pressures.

### SUMMARY OF INVENTION

One embodiment of the present invention comprises a brush seal wherein the brush seal is disposed in a section of a steam turbine for reducing leakage of a working fluid across a pressure drop. The brush seal comprises a bristle holder attachable to the steam turbine and a plurality of bristles comprising Ni, Cr, Mo, Fe, W, Mn, V, Si, and C.

### BRIEF DESCRIPTION OF DRAWINGS

These and other features, aspects, and advantages of the present invention will become better understood when the following detailed description is read with reference to the accompanying drawings in which like characters represent like parts throughout the drawings, wherein:

FIG. 1 is a cross-sectional view a brush seal for a steam turbine in accordance with one embodiment of the present invention.

### DETAILED DESCRIPTION

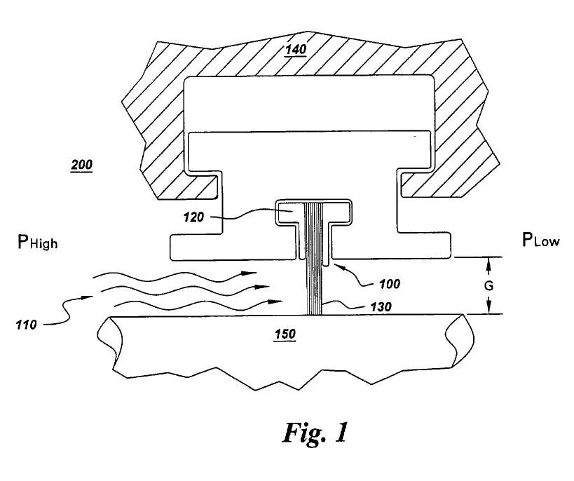

A brush seal 100 is provided in a section of a steam turbine 200 for reducing leakage of a working fluid 110 across a pressure drop (see FIG. 1). For purposes of describing the invention, it is understood that the terminology “brush seal” includes, without limitation, a segment of a brush seal that is manufactured in segments that are arrayed together to form a complete brush seal. As used herein, the term “working fluid” refers to a fluid, typically steam, that has been generated in a steam-generating device and introduced into the steam turbine 200. The steam turbine 200 is typically coupled to a steam source deriving its energy from a nuclear plant, fossil-fuel plant or combined cycle plant. The brush seal 100 typically comprises a (meaning at least one) bristle holder 120 attachable to a (meaning at least one) plurality of bristles 130. In one embodiment, the plurality of bristles 130 comprise Ni, Cr, Mo, Fe, W, Mn, V, Si, and C. In another embodiment, the brush seal 100 comprises a plurality of bristles 130 consisting essentially of Ni, Cr, Mo, Fe, W, Co, Mn, V, Si, and C. In an exemplary embodiment, each of the plurality of bristles 130 comprise about 16% Cr, about 16% Mo, about 5% Fe, about 4% W, less than about 2.5% Co, about 1% Mn, about 0.35% V, about 0.08 Si, about 0.01% C and a remainder of Ni. In another exemplary embodiment, each of the plurality of bristles 130 consists essentially of Hastelloy C-276™ (offered for sale by Haynes International, Kokomo, Ind.).

In another embodiment, the brush seal 100 is provided for the steam turbine 200. The steam turbine 200 comprises a stator 140 disposed in the steam turbine 200. As used herein, the terms “thereon”, “therein”, “over”, “above”, “under”, “on”, “in” and the like are used to refer to the relative location of elements of the present invention as illustrated in the FIGURE and are not meant to be a limitation in any manner with respect to the orientation or operation of the present invention. In this embodiment, a rotor 150, generally coaxially aligned with the stator 140, is radially spaced apart from the stator 140 to define a gap (defined “G” in the drawing FIGURE) between the stator 140 and the rotor 150. The brush seal 100, as described herein, is disposed in a low-temperature or a low-temperature and low-pressure section of the steam turbine 200. As used herein, the term “low-temperature” refers to operating temperatures of a particular section in the steam turbine 200 operating in the range between about 100° F. and about 500° F. The term, “low-pressure”, as used herein, refers to an operating pressure of a particular section in the steam turbine 200 wherein the operating pressure is up to about 160 psia. Typically, the stator 140 circumferentially surrounds the rotor 150; however, other applications typically comprise the rotor 150 circumferentially surrounding the stator 140. The working fluid 110 is disposed in the gap “G”, wherein the working fluid 110 has a pressure drop generally transverse to the gap “G”, and wherein the pressure drop is generated during operation of the steam turbine 200. For illustrative purposes, it will be appreciated, however, that the working fluid 110 in a fluid path flows from the high pressure side, designated “Phigh”, towards the low pressure side, designated “Plow”, i.e., from the left to right of drawing FIG. 1.

In another embodiment of the present invention, the brush seal 100 is provided for a steam turbine 200 deriving its energy from the nuclear plant. In such conventional steam turbines, the brush seal 100 comprises bristles 130 having cobalt-based bristles that, at times, become radioactive if exposed to nuclear reactor steam. As a result, disposal of such radioactive seals is problematic when servicing the nuclear steam turbine. In one embodiment of the present invention, the brush seal 100 comprises a plurality of bristles 130 having a low radiation activation material thus facilitating disposal of such material. As used herein, the term “low radiation activation material” refers to a predetermined cobalt content in such material so that it does not allow the bristles 130 to become radioactive. The low radiation activation material typically comprises about 16% Cr, about 16% Mo, about 5% Fe, about 4% W, less than about 2.5% Co, about 1% Mn, about 0.35% V, about 0.08 Si, about 0.01% C and a remainder of Ni. In an exemplary embodiment, the low radiation activation material comprises Hastelloy C-276™ (offered for sale by Haynes International, Kokomo, Ind.). In this embodiment, the brush seal 100 for the steam turbine 200 deriving its energy from the nuclear plant includes the details and operates as described herein.

In another embodiment of the present invention, the brush seal 100 is provided for the steam turbine 200 deriving its energy from the fossil-fuel plant. In this embodiment, the working fluid 110 is generated in a boiler that uses a fossil-fuel, typically coal, as the energy source. The working fluid 110 is typically disposed in the gap “G” between the stator 140 and the rotor 150 and has a pressure drop generally transverse to the gap “G”. The pressure drop is typically generated during operation of such turbine. In yet another embodiment of the present invention, the brush seal 100 is provided for the steam turbine 200 deriving its energy from the combined-cycle plant. As used herein, the term “combined-cycle plant” refers to steam turbines that generate the working fluid 100 (e.g. steam) in a heat exchanger that uses exhaust gas heat from a gas turbine to generate steam. In the embodiments described above, the brush seal 100 for such turbines includes the details and operates as described herein.

A method of retrofitting the steam turbine 200 is provided and comprises providing a stator 140, wherein the stator 140 is disposed in the steam turbine 200. This embodiment further comprises providing a rotor 150, wherein the rotor 150 is spaced apart from the stator 140 so as to define the gap “G” therebetween and providing a brush seal 100, wherein the brush seal 100 is disposable in a section of the steam turbine 200. The method of retrofitting the steam turbine 200 further comprises operating the section of the steam turbine 200 at a temperature in the range between about 100° F. and about 500° F. In another embodiment, the method of retrofitting the steam turbine 200 comprises operating the section of the steam turbine 200 at a pressure up to about 160 psia.

One aspect of the invention is that at the low-temperatures and the low-pressures discussed above, the brush seal 100 of the present invention has superior wear properties compared to conventional brush seals at the same temperatures and pressures. By way of example and not limitation, some conventional steam turbines typically utilize cobalt-based brush seals, for example Haynes 25™ (offered for sale by Haynes International, Kokomo, Ind.) brush seals. While such cobalt-based brush seals have proved to be reliable in sections of steam turbines having operating temperatures between about 500° F. and about 1100° F. and pressures between about 140 psia and about 3560 psia, wear performance of such seals typically degrades at temperatures between about 100° F. and about 500° F. wherein such temperatures typically correspond to sections of the turbine where pressures are generally up to 140 psia. At the low-temperatures and low-pressures described herein, the cobalt-based brush seal typically causes unwanted rotor 150 wear when the steam turbine 200 is in operation. By way of example and not limitation, such rotors 150 typically comprise CrMoV or NiCrMoV rotors.

Applicants conducted experiments in a test rig to simulate conditions of the brush seal of the present invention disposed in a steam turbine 200. An aspect is discussed in the following example.

A brush seal comprising about 15% Cr, 16% Mo, 5% Fe, 3.1% W, 1.7% Co, 0.46% Mn, 0.15% V, about 0.08 Si, about 0.01% C and 56% Ni was disposed adjacent a rotor to allow testing of the brush seal at various bristle to rotor clearances (also known as assembly clearance). The brush seal that was used had a bristle pack density of about 1900 bristles per inch and a bristle diameter of about 0.0056 inches. In addition, a cant angle between the rotor and bristles was about 45 degrees. The test comprised spinning the rotor at a surface speed of about 400 feet per second in compressed gas.

The results indicated that for assembly clearances up to 0.025 inches the resistance to leakage between the seal and the rotor was three to ten times of an improvement compared to traditional labyrinth-type seals that are typically used in low-pressure steam turbine applications. The measured brush seal leakage rate in the abovementioned test indicated that the gap “G” was in the range between about 0.004 inches and about 0.005 inches compared to the traditional labyrinth-type seals that typically have a gap “G” in the range between about 0.015 inches and about 0.025 inches.

Furthermore, accelerated wear tests were conducted in which the brush seal of the present invention was allowed to interfere with a spinning NiCrMoV rotor at a temperature about 325° F. in saturated steam for a time of about 40 hours. The results of the accelerated wear tests indicated that the measured bristle-to-rotor wear was negligible (e.g. no measurable wear characteristics) compared to cobalt-based brush seals at similar conditions (e.g. cobalt-based brush seal having measurable wear in the range between about 0.003 inches and about 0.005 inches). As such, the accelerated wear tests indicated improved sealing capability between the rotor and brush seal of the present invention compared to conventional cobalt-based brush seals.

It will be apparent to those skilled in the art that, while the invention has been illustrated and described herein in accordance with the patent statutes, modification and changes may be made in the disclosed embodiments without departing from the true spirit and scope of the invention. It is, therefore, to be understood that the appended claims are intended to cover all such modifications and changes as fall within the true spirit of the invention.

1. A brush seal, disposed in a section of a steam turbine, for reducing leakage of a working fluid across a pressure drop, said brush seal comprising:
a bristle holder attachable to said steam turbine; and
a plurality of bristles coupled to said bristle holder, said plurality of bristles comprising Ni, Cr, Mo, Fe, W, Mn, V, Si, and C.

2. The brush seal of claim 1, wherein an energy source of said steam turbine is selected from the group consisting essentially of nuclear plants, fossil-fuel plants and combined cycle plants.

3. The brush seal of claim 1, wherein each of said plurality of bristles comprises about 16% Cr, about 16% Mo, about 5% Fe, about 4% W, less than about 2.5% Co, about 1% Mn, about 0.35% V, about 0.08 Si, about 0.01% C and a remainder of Ni.

4. The brush seal of claim 1, wherein the operating temperature of said section is in the range between about 100° F. and about 500° F.

5. The brush seal of claim 1, wherein the operating pressure of said section is up to about 160 psia.

6. A brush seal, disposed in a section of a steam turbine, for reducing leakage of a working fluid across a pressure drop, said brush seal comprising:
a bristle holder attachable to said steam turbine; and
a plurality of bristles coupled to said bristle holder, said plurality of bristles comprising a low radiation activation material, said material having less than 2.5% Cobalt by weight.

7. The brush seal of claim 6, wherein an energy source of said steam turbine is selected from the group consisting essentially of nuclear plants, fossil-fuel plants and combined cycle plants.

8. The brush seal of claim 6, wherein each of said plurality of bristles comprises about 16% Cr, about 16% Mo, about 5% Fe, about 4% W, about 1% Mn, about 0.35% V, about 0.08 Si, about 0.01% C and a remainder of Ni.

9. The brush seal of claim 6, wherein the operating temperature of said section is in the range between about 100° F. and about 500° F.

10. The brush seal of claim 6, wherein the operating pressure of said section is up to about 160 psia.

11. A steam turbine comprising:
a stator disposed in said steam turbine;
a rotor spaced apart from said stator so as to define a gap therebetween; and
a brush seal disposed in a section of said steam turbine, said brush seal comprising:
a)a bristle holder coupled to said stator; and
b)a plurality of bristles coupled to said bristle holder and wherein said plurality of bristles consists essentially of Ni, Cr, Mo, Fe, W, Co, Mn, V, Si, and C.

12. The steam turbine of claim 11, wherein an energy source of said steam turbine is selected from the group consisting essentially of nuclear plants, fossil-fuel plants and combined cycle plants.

13. The steam turbine of claim 11, wherein each of said plurality of bristles comprises about 16% Cr, about 16% Mo, about 5% Fe, about 4% W, less than about 2.5% Co, about 1% Mn, about 0.35% V, about 0.08 Si, about 0.01% C and a remainder of Ni.

14. The steam turbine of claim 11, wherein the operating temperature of said section is in the range between about 100° F. and about 500° F.

15. The steam turbine of claim 11, wherein the operating pressure of said section is up to about 160 psia.

16. A method of retrofitting a steam turbine comprising:
providing a stator; said stator disposed in said steam turbine;
providing a rotor, said rotor spaced apart from said stator so as to define a gap therebetween; and
providing a brush seal, said brush seal being disposable in a section of said steam turbine,
wherein said brush seal comprises a plurality of bristles having about 16% Cr, about 16% Mo, about 5% Fe, about 4% W, less than about 2.5% Co, about 1% Mn, about 0.35% V, about 0.08 Si, about 0.01% C and a remainder of Ni.

17. The method of claim 16, further comprising operating said section of said steam turbine at a temperature in the range between about 100° F. and about 500° F.

18. The method of claim 16, further comprising operating said section of said steam turbine at a pressure up to about 160 psia.
